(19) United States
(12) Patent Application Publication
(10) Pub. No.: US 2026/0128572 A1
(43) Pub. Date: May 7, 2026

(54) Systems and Methods for Lash Wire Application and Tension Control

(71) Applicant: Lash Logic Innovations IP Holdings LLC, Daytona Beach, FL (US)

(72) Inventors: Orrette Omario Forbes, Daytona Beach, FL (US); Vuk Knezevic, Daytona Beach, FL (US)

(73) Assignee: Lash Logic Innovations IP Holdings LLC, Daytona, FL (US)

(21) Appl. No.: 19/314,568

(22) Filed: Aug. 29, 2025

Related U.S. Application Data
(60) Provisional application No. 63/691,043, filed on Sep. 5, 2024.

(51) Int. Cl. H02G 1/02; H02G 7/10

(52) U.S. Cl. CPC H02G 1/02; H02G 7/10

(57) ABSTRACT

The present disclosure provides a cable bundle lasher comprising a body configured to be positioned on one or more cables, a lash wire magazine coupled to the body and configured to hold a spool of lash wire for wrapping around the one or more cables, and an automated lash wire tension adjuster coupled to the body. The lash wire magazine includes a first reel guide to guide lash wire exiting the spool. The automated lash wire tension adjuster is configured to receive the lash wire from the magazine and comprises a tension sensor responsive to lash wire tension during operation of the lasher, and a local tension adjuster configured to receive a signal indicative of lash wire tension and to adjust lash wire tension in response to the signal.

### TECHNICAL FIELD

This invention relates to cable lashing devices, and more particularly to systems and methods for lash wire application and tension control.

### BACKGROUND OF THE INVENTION

Cable lashing devices are an essential tool in the telecommunications and utility industries for securing cable bundles to support wires or structures. These devices play a pivotal role in the installation and maintenance of aerial cable systems, ensuring the longevity and reliability of communication and power networks.

However, challenges persist in the field of cable lashing. Cable lashing is a labor-intensive manual process, prone to inconsistencies and potential safety hazards. For example, cable lashing often includes issues with maintaining consistent tension across varying cable bundle diameters, adapting to different lashing speeds, and ensuring durability in diverse environmental conditions.

### SUMMARY OF THE INVENTION

In an example implementation, a cable bundle lasher is provided. The cable bundle lasher comprises a body configured to be positioned on one or more cables; a lash wire magazine coupled to the body and configured to hold a spool of lash wire for wrapping around the one or more cables, the magazine comprising a first reel guide to guide lash wire exiting the spool; an automated lash wire tension adjuster coupled to the body and configured to receive the lash wire from the magazine. The automated lash wire tension adjuster comprising a tension sensor responsive to lash wire tension during operation of the lasher; and a local tension adjuster configured to receive a signal indicative of lash wire tension and to adjust lash wire tension in response to the signal.

An aspect combinable with the example implementation further includes a tension support structure coupled to the body, the tension support structure comprising: an upper plate; a base plate; and an outer bracket coupling the upper plate to the base plate.

Another aspect combinable with one, some, or all of the previous aspects further includes a reel shaft coupled to the outer bracket, the reel shaft comprising a second reel guide to guide the lash wire.

In another aspect combinable with one, some, or all of the previous aspects, the local tension adjuster is a motor or an electric actuator.

In another aspect combinable with one, some, or all of the previous aspects, the first reel guide operates about a vertical axis.

In another aspect combinable with one, some, or all of the previous aspects, the second reel guide comprising one or more tension drag wheels, wherein the second reel guide operates about a horizontal axis.

In another aspect combinable with one, some, or all of the previous aspects, the sensor comprising a strain gauge.

In another aspect combinable with one, some, or all of the previous aspects, the sensor is a three-roller tension sensor.

In another aspect combinable with one, some, or all of the previous aspects, the tension measurement is based on a strain gauge of the lashing wire.

In another aspect combinable with one, some, or all of the previous aspects, further including a computing device coupled to the body, wherein the computing device is configured to monitor measurements from the tension sensor and operate the local tension adjuster to maintain tension of the lash wire.

In another example implementation, a method of lashing a cable bundle, is provided. The method comprising positioning one or more cables within a cavity of a cable bundle lasher; dispensing lashing wire from a magazine housing coupled to the cable bundle lasher; sensing tension of the lashing wire during a lashing operation; generating a signal indicative of the sensed lashing wire tension; adjusting the tension of the lashing wire based on the generated signal; and controlling the adjustment of the lashing wire tension using a computing device coupled to the cable bundle lasher.

In an aspect combinable with the example implementation, sensing tension of the lashing wire comprises using a strain gauge or load cell.

In another aspect combinable with one, some, or all of the previous aspects, adjusting the tension of the lashing wire comprises operating an electric actuator.

In another aspect combinable with one, some, or all of the previous aspects, further includes managing the one or more cables prior to positioning them within the cavity using a robotic arm assembly coupled to the cable bundle lasher.

In another aspect combinable with one, some, or all of the previous aspects, further includes maneuvering the cable bundle lasher along the one or more cables using the robotic arm assembly coupled to the cable bundle lasher.

In another aspect combinable with one, some, or all of the previous aspects, further includes applying pressure to the one or more cables with the robotic arm assembly to move the cable bundle lasher.

In another example implementation, cable bundle lasher is provided comprising a body defining a cavity configured to receive one or more cables; a lashing wire dispenser coupled to the body and configured to dispense lashing wire; a tension sensor responsive to lash wire tension during operation of the lasher; a local tension adjuster configured to receive a signal indicative of lash wire tension and to adjust lash wire tension in response to the signal; and a computing device coupled to the body, wherein the computing device is configured to monitor measurements from the tension sensor and operate the local tension adjuster to maintain tension of the lash wire.

In an aspect combinable with the example implementation, the tension sensor comprises a strain gauge or load cell.

In another aspect combinable with one, some, or all of the previous aspects, the local tension adjuster comprises an electric actuator configured to adjust tension of the lashing wire. [0023] In another aspect combinable with one, some, or all of the previous aspects, further includes a robotic arm assembly coupled to the body and configured to manage the one or more cables prior to entering the cavity.

In another example implementation, a system for automated cable bundle lashing is provided comprising: a cable bundle lasher including a body defining a cavity for receiving one or more cables; a lashing wire dispenser coupled to the cable bundle lasher; an automated lash wire tension adjuster including: a tension sensor responsive to lash wire tension, and a local tension adjuster configured to adjust lash wire tension; and a computing device coupled to the cable bundle lasher and configured to control the automated lash wire tension adjuster based on measurements from the tension sensor.

In an aspect combinable with the example implementation, the tension sensor comprises a strain gauge or load cell configured to measure force applied to the lashing wire.

In another aspect combinable with one, some, or all of the previous aspects, the local tension adjuster comprises an electric actuator configured to adjust tension of the lashing wire based on signals from the computing device.

In another aspect combinable with one, some, or all of the previous aspects, further includes a robotic arm assembly coupled to the cable bundle lasher and configured to manage the one or more cables prior to entering the cavity.

In another aspect combinable with one, some, or all of the previous aspects, the computing device is configured to execute at least one of an initialization procedure, an acquisition procedure, an analysis procedure, a tension adjustment procedure, a speed procedure, or a completion procedure.

In another aspect combinable with one, some, or all of the previous aspects, the tension adjustment procedure comprises: determining a tension measurement based on a weight of the one or more cables and a tension factor; and determining an adjusted tension measurement based on the tension measurement, a tension increase factor, and a slope angle.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a cable lashing environment including a cable bundle lasher;

FIG. 1B is a top perspective view of the cable bundle lasher;

FIG. 1C is a bottom perspective view of the cable bundle lasher;

FIG. 2A is a top perspective view of an automated lash wire tension adjuster of the cable bundle lasher;

FIG. 2B is a partial view of the automated lash wire tension adjuster of the cable bundle lasher;

FIG. 2C is a bottom perspective view of the automated lash wire tension adjuster of the cable bundle lasher;

FIG. 2D is another top perspective view of the automated lash wire tension adjuster of the cable bundle lasher;

FIG. 3A is a top perspective view of a body of the cable bundle lasher;

FIG. 3B is a bottom perspective view of the body of the cable bundle lasher;

FIG. 4A is a front perspective view of a back latch of the cable bundle lasher;

FIG. 4B is a rear perspective view of the back latch of the cable bundle lasher;

FIG. 5A is a front perspective view of a front latch of the cable bundle lasher;

FIG. 5B is a bottom perspective view of the front latch of the cable bundle lasher;

FIG. 6 is a perspective view of a tension drag wheel assembly of the cable bundle lasher;

FIG. 7A is front perspective view of a cable clamp assembly of the cable bundle lasher;

FIG. 7B is a rear perspective view of the cable clamp assembly of the cable bundle lasher;

FIG. 8 is a perspective view of a housing of the cable bundle lasher;

FIG. 9 is a flowchart of an example method of adjusting tension of lash wire; and

FIG. 10 shows a schematic drawing of a control system.

Like reference symbols in the various drawings indicate like elements.

### DETAILED DESCRIPTION

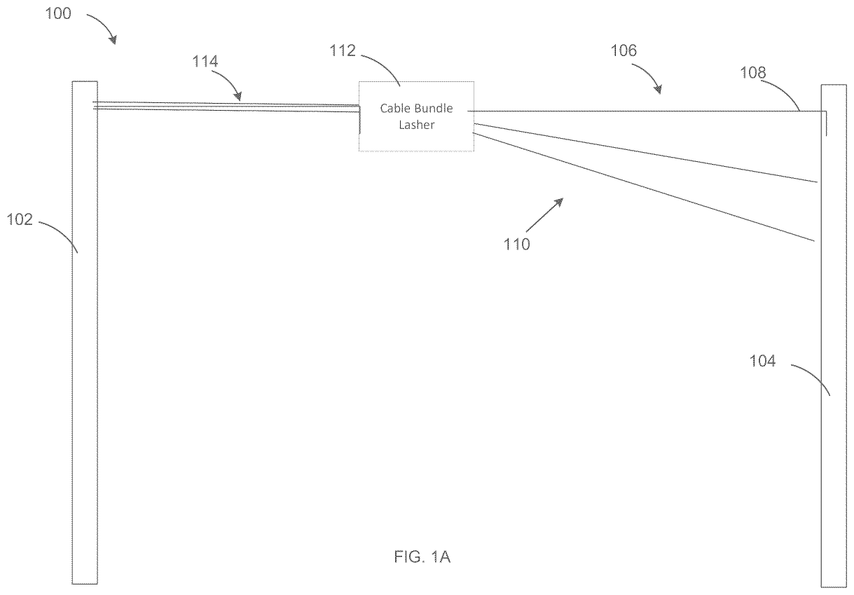

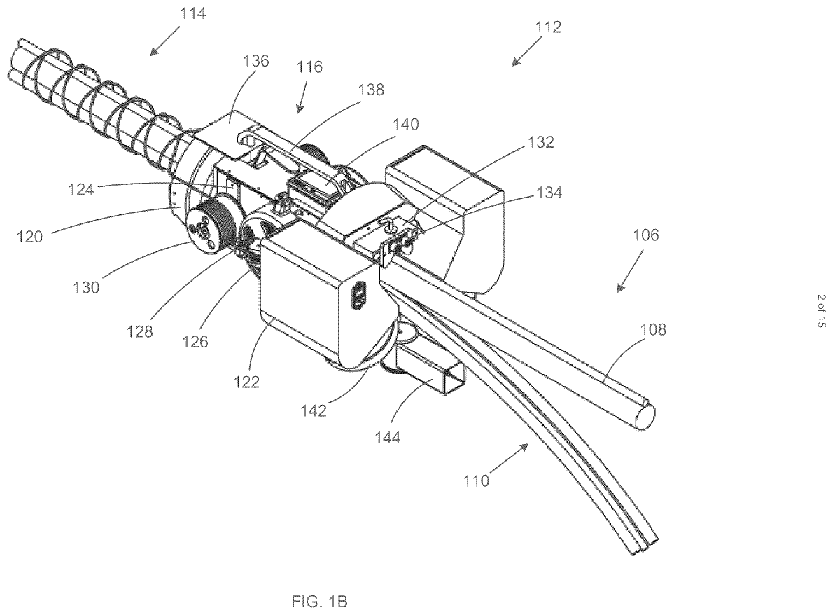

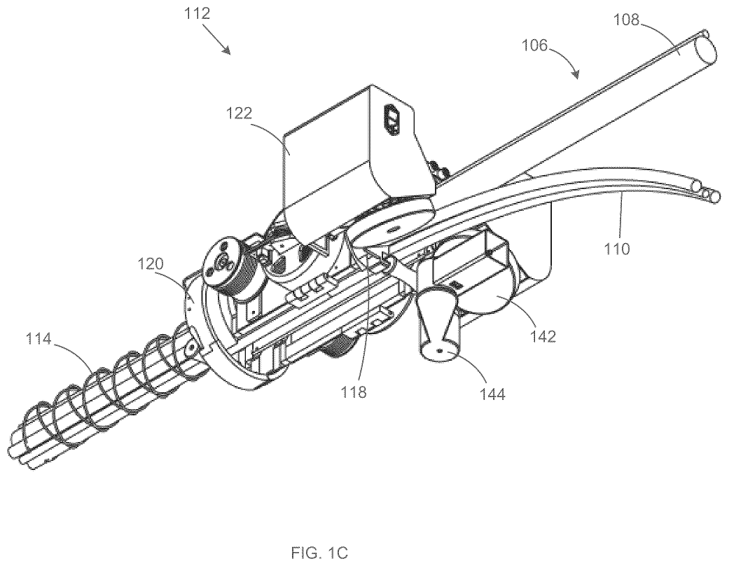

Referring to FIG. 1, a cable lashing environment 100 is illustrated, which can represent a variety of settings such as telecommunications infrastructure or utility installations. The environment 100 includes a first structure 102 and a second structure 104, which are spaced apart from each other. In some embodiments, the first structure 102 and the second structure 104 can be telephone poles, utility poles, buildings, or other suitable structures capable of supporting cables.

Between the first structure 102 and the second structure 104, one or more cables 106 are extended. The one or more cables comprise a guide cable 108 and a cable bundle 110. The guide cable 108 is configured to provide support to a cable bundle lasher 112 and to enable the cable bundle lasher 112 to lash the cable bundle 110 to the guide cable 108. Depending on the specific application within the environment 100, these cables 106 (e.g., the guide cable 108, the cable bundle 110) can vary in type and function. For instance, the one or more cables 106 can include fiber optic cables for high-speed data transmission in telecommunications networks, coaxial cables for cable television or broadband internet services, copper wire cables for traditional telephone lines or electrical power distribution, bundled cables combining multiple types for comprehensive utility services, or messenger wires or support cables to provide structural support for other cables. In example implementations, the guide cable 108 can vary in size and material depending on the type of cable bundle 110.

The cable bundle 110 is secured to the guide cable 108 to form a lashed cable bundle 114. To achieve this, the cable bundle lasher 112 is positioned on the guide cable 108. The cable bundle lasher 112 applies lashing wire around the one or more cables 106 as it moves along their length, effectively binding them together to create the lashed cable bundle 114.

The cable bundle lasher 112 organizes and secures the one or more cables 106, providing several benefits. For example, the cable bundle lasher 112 improves the structural integrity of the cable bundle 114, protects against environmental factors such as wind, ice, and UV radiation, simplifies maintenance and future cable additions or removals, and reduces strain on individual cables and supporting structures.

The lashed cable bundle 114, resulting from the operation of the cable bundle lasher 112, provides improved longevity and performance compared to unsecured cables. This lashing process helps maintain the reliability and efficiency of the cable infrastructure within the environment 100, whether it be for telecommunications, power distribution, or other utility applications.

Referring now to FIGS. 1B and 1C, the cable bundle lasher 112 includes a body 116, a front latch 118, a back latch 120, a housing 122, a tension drag wheel assembly 124, a magazine housing 126, a tension sensor 128, a reel guide 130, a cable clamp assembly 132, a distance sensor 134, a base plate 136, a handle 138, a computing device 140, guide wheels 142, and a robotic arm 144.

The body 116 provides a support structure upon which other components can be coupled. The body also defines a cavity (discussed in more detail below) that operates to provide a space for the guide cable 108 and the guide cable 108 to be bundled prior to lash wire being applied to the one or more cables 106 (e.g., the guide cable 108 and the guide cable 108).

The front latch 118 is coupled to the body 116 at a first end and secures portions of the one or more cables 106 so that the one or more cables 106 can be lashed.

The back latch 120 is coupled to the body 116 at a second end opposite the first end (i.e., opposite the front latch 118) and secures portions of the one or more cables 106 so that the one or more cables 106 can be lashed. The front latch 118 and the back latch 120 secure the one or more cables 106 to ensure they are positioned in a manner so that the one or more cables 106 can be lashed.

The housing 122 is coupled to the body 116 and the back latch 120. The housing 600 is configured to house motors and batteries that provide power to operate the cable bundle lasher 112. The motors may drive various components of the cable bundle lasher 112, such as the lashing system, an automated lash wire tension adjuster, an actuator assembly, and/or the guide wheels 142. The batteries provide a portable power source for the cable bundle lasher 112, allowing the cable bundle lasher 112 to operate in a variety of environments without the need for a constant external power supply.

The tension drag wheel assembly 124 is coupled to the body 116 and provides a support structure for the magazine housing 126, the tension sensor 128 and the reel guide 130. The magazine housing 126 houses lashing wire to be applied to the one or more cables 106. The tension sensor 128 is coupled to the body 116 and receives lash wire from the magazine housing 126 to monitor the tension of the lash wire. The reel guide 130 is coupled to the tension drag wheel assembly 124 and receives the lash wire from the magazine housing 126 via the tension sensor 128. A motor is coupled to the reel guide 130 and operates in response to a signal from the computing device 140 when the tension sensor 128 measures tension of the lash wire is above/below a threshold tension measurement. For example, the lash wire can operate within a specific tension range to prevent it from either snapping or being too slack. The tension threshold can be set between 10 Newtons (N) and 30 Newtons (N). If the tension sensor 128 measures a tension drop below 10 N, the computing device 140 can operate the motor coupled to the reel guide 130 and increase the reel guides 130 torque to tighten the lash wire. If the tension sensor 128 measures a tension increase beyond 30 N, the computing device 140 can operate the motor coupled to the reel guide 130 to decrease the torque, or can disengage the motor from the reel guide 130 to enable the reel guide 130 to spin freely to prevent the lash wire from snapping. In some examples, the tension drag wheel assembly 124, the magazine housing 126, the tension sensor 128 and the reel guide 130 can be referred to as an automated lash wire tension adjuster.

The cable clamp assembly 132 is coupled to the body 116 via the back latch 120 and/or the housing 122. The cable clamp assembly 132 provides support to the guide cable 108. For example, the cable clamp assembly is operated to be placed on the guide cable 108 to provide a secure connection for the cable bundle lasher 112 on the guide cable 108.

The distance sensor 134 is coupled to the back latch 120 and the cable clamp assembly 132 for determining where the cable bundle lasher is relative to the first structure 102 and the second structure 104. The front latch 118 can also include the distance sensor 134. That is, the front latch 118 and the back latch 120 can both include a distance sensor 134 to enable the computing device 140 to determine a positioning of the cable bundle lasher 112 relative to the first structure 102 and the second structure 104. In some examples, the distance sensor 134 can be an Ultrasonic HCSR04 sensor. However, other sensors that measure distance may also be used.

The base plate 136 is coupled to the body 116 and can be utilized to coupled other components or accessories to the cable bundle lasher 112. The handle 138 is coupled to the base plate 136. In some examples, the handle 138 can be operated by an individual to position the cable bundle lasher 112 on the one or more cables 106. This enables the cable bundle lasher 112 to be positioned on the one or more cables 106 in difficult-to-reach locations, improving the safety and efficiency of the lashing process.

The computing device 140 is coupled to the body 116. The computing device 140 is configured to control various aspects of the lashing process. For example, the computing device 140 controls the tension of the lash wire, monitors the slope of the cable bundle lasher 112 to determine its speed, determine how much tension is needed, and monitor sensors of the cable bundle lasher 112 to determine how far along the cable bundle lasher 112 is on the one or more cables 106 between the first structure 102 and the second structure 104. This allows for precise and automated control of the lashing process, improving the quality and consistency of the lashed cable bundle 114. For example, the computing device 140 can perform various functions prior to, during, and after the lashing process. The computing device 140 can execute an initialization procedure, an acquisition procedure, an analysis procedure, a tension adjustment procedure, a speed procedure, and/or a completion procedure.

During the initialization procedure, the computing device 140 initializes by reading the initial conditions of the cable bundle lasher 112. The computing device 140 can connect to various sensors and components, including tension sensors (e.g., measures tension of lash wire), slope sensors (e.g., measure angle of the cable bundle lasher 112 relative to a horizontal plane), and position sensors (e.g., measures distance of cable bundle lasher 112 between structures), to gather the starting data. The computing device 140 can also receive measurements from the robotic arm 144 such as position measurements, weight measurements, and force measurements. [0067] During the acquisition procedure, the computing device 140 continuously monitors the tension of the lash wire using the tension sensor, slope of the cable bundle lasher 112 through the slope sensor (e.g., accelerometer, inclinometer, etc.), and position along the cable bundle using distance sensors or encoders. The tension sensor detects the force being applied to the lash wire to determine if adjustments are needed. The tension sensor continuously measures the lash wire tension to ensure it is within the required range. The slope sensor measures the angle of the cable bundle lasher 112 relative to the ground, which affects the speed and tension required during lashing. If the slope increases, it indicates that the cable bundle lasher 112 is going uphill, requiring more tension to maintain a steady movement. If the slope decreases, the cable bundle lasher 112 is going downhill, and tension needs to be reduced to prevent the lash wire from loosening. The position sensor tracks the progress of the cable bundle lasher 112 between the first structure 102 and the second structure 104.

During the analysis procedure, the computing device 140 processes data from these sensors to assess the current state of the lashing operation. If the slope indicates that the cable bundle lasher 112 is moving uphill, the computing device 140 adjusts the speed and tension accordingly to maintain consistency in lashing. If the tension exceeds or drops below a predefined threshold (based on the computing device 140 calculation of the tension needed for a secure lash), the computing device 140 signals the tension adjustment procedure.

During the tension adjustment procedure, the computing device 140 controls an actuator to apply more or less resistance to maintain the appropriate tension. The computing device 140 can adjust the tension in real-time based on continuous feedback from the tension sensor. This ensures that the lash wire remains at optimal tension throughout the lashing process. [0070] During the speed procedure, the computing device 140 calculates a speed for the cable bundle lasher 112 based on the slope and position data. For example, the computing device 140 may slow down on inclines or speed up on declines, ensuring even lashing. The computing device 140 uses position data to determine how much of the lashing operation is complete and adjusts the process as needed to ensure that the entire cable bundle 110 is lashed evenly and securely.

During the completion procedure, the computing device 140 ensures that the lash wire is secured, and the tension is released in a controlled manner once the cable bundle lasher 112 reaches the second structure 104. The computing device 140 then stores the data for the entire operation, which can be used for quality control and to inform future lashing operations.

The guide wheels 142 are coupled to the cable bundle lasher 112 via the housing 122. The guide wheels 142 are configured to be applied to the one or more cables 106 to maneuver the cable bundle 110 towards the guide cable 108 into the body 116 of the cable bundle lasher 112 along the one or more cables 106 between the first structure 102 and the second structure 104. In some examples, the wheels 142 can apply pressure to the one or more cables 106 to increase friction and reduce slipping. This helps maintain the tension of the lash wire during the lashing process, ensuring a secure and consistent lashing of the one or more cables 106. In some embodiments, the wheels 142 are positioned on the guide cable 108 and as the cable bundle lasher 112 moves along the guide cable 108, the cable bundle 110 passes through the wheels 142 and into the body 116 to be lashed to the guide cable 108.

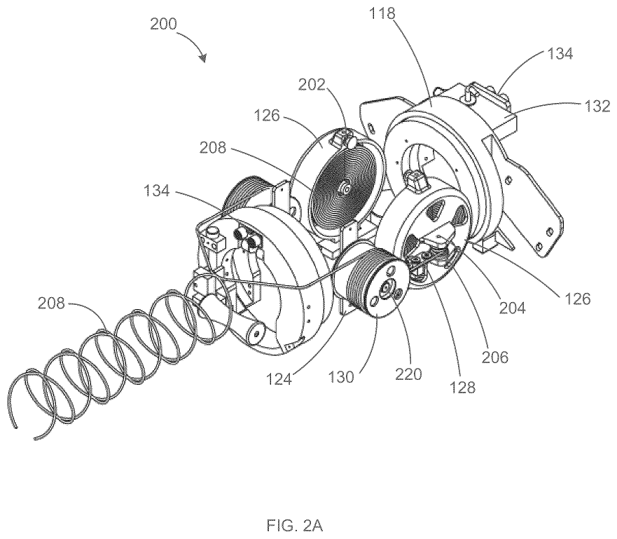

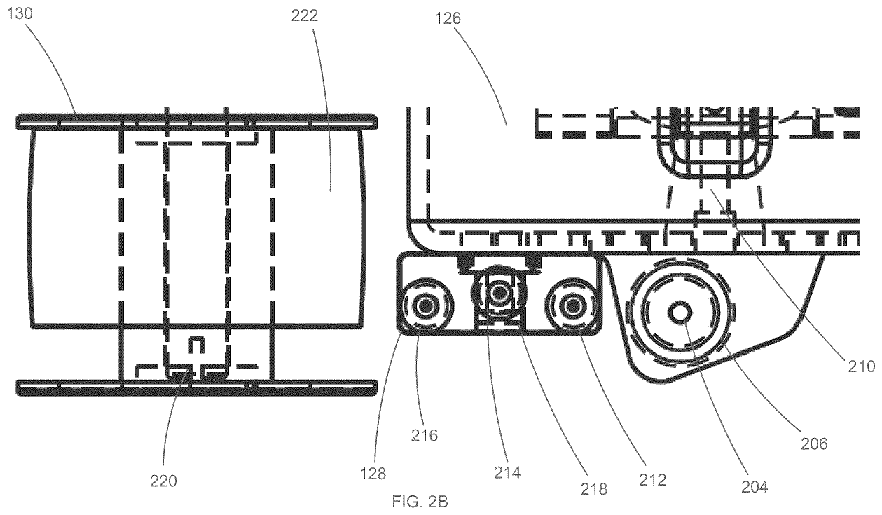

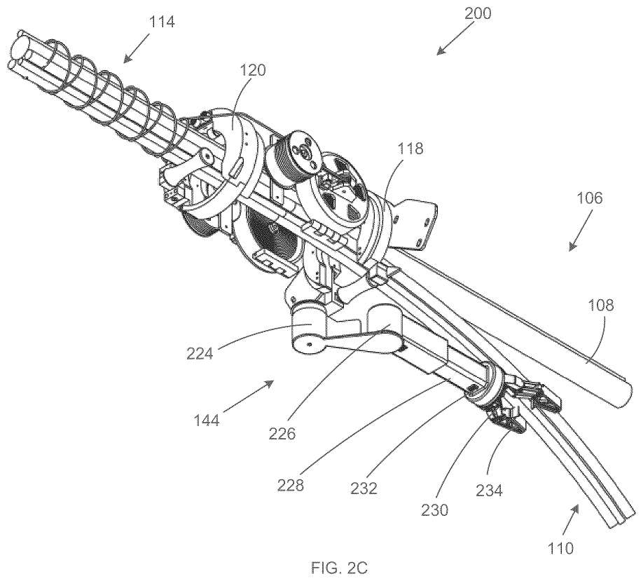

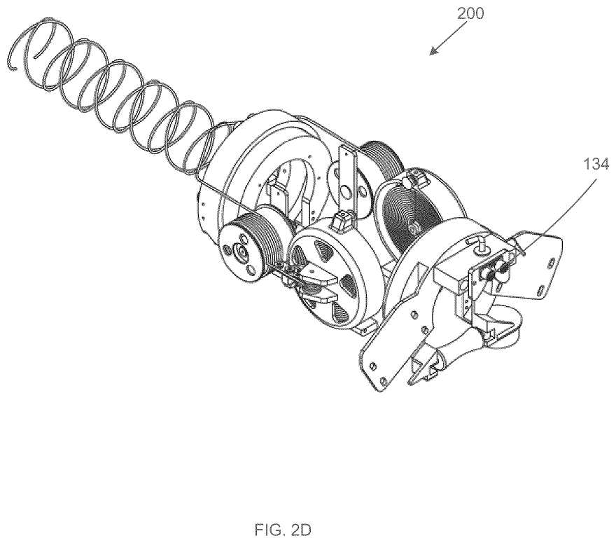

The robotic arm 144 is coupled to the body 116 of the cable bundle lasher 112. Briefly, the robotic arm 144 includes an end effector that grabs the cable bundle 110 and pulls the cable bundle lasher 112 along the guide cable 108. The robotic arm 144 ensures that the one or more cables 106 are properly aligned and bundled together for the lashing process. The robotic arm 144 is configured to pull the cable bundle lasher 112 along the guide cable 108 by pulling the cable bundle 110 in a manner that enables the cable bundle lasher 112 to maintain proper tension of the lash wire to improve the structural integrity of the cable bundle 114. The robotic arm 144 is discussed in more detail below in connection with FIG. 2C.

Turning now to FIG. 2A, an automated lash wire tension adjuster 200 of the cable bundle lasher 112 is coupled to the body 116 of the cable bundle lasher 112. The automated lash wire tension adjuster 200 includes various components such as the front latch 118, the back latch 120, the tension drag wheel assembly 124, the magazine housing 126, the tension sensor 128, the reel guide 130, and the cable clamp assembly 132. These components work together to adjust the tension of the lash wire during the lashing process, ensuring a consistent and secure lashing of the one or more cables 106.

The automated lash wire tension adjuster 200 includes the magazine housing 126. The magazine housing 126 is configured to be coupled to a hinge bracket of the body 116. The magazine housing 126 includes a locking mechanism 202 to further strengthen the coupling to the body 116. The magazine housing 126 includes a reel shaft 204 and a reel guide 206. The magazine housing 126 is configured to hold and disperse lashing wire 208. In particular, the magazine housing 126 disperses the lashing wire 208 which is wrapped and maneuvers about the reel guide 206.

The automated lash wire tension adjuster 200 further includes the tension sensor 128. In some embodiments, the tension sensor 128 can be a strain gauge or a load cell. These sensors are configured to measure tension in the lashing wire. A strain gauge may be attached to a part of the spool mechanism to measure the amount of force being applied to the wire. Alternatively, the tension sensor 128 may be a rotary encoder. This can be used to monitor the rotational speed of the spool, indirectly inferring tension based on the speed and force required to pull the wire. The tension sensor 128 may receive the lashing wire 208 from the magazine housing 126 and monitor the tension of the lash wire 208.

The automated lash wire tension adjuster 800 includes the reel guide 130 (e.g., a local tension adjuster). The local tension adjuster 130 may use electronic tension control. The local tension adjuster 130 can be configured to receive a signal indicative of lash wire tension and to adjust lash wire tension in response to the signal to maintain precise tension. The local tension adjuster 130 can automatically adjust tension based on lashing speed or cable bundle characteristics, offering precision and consistency.

In some embodiments, the local tension adjuster 130 can be coupled to a motor or an electric actuator that adjusts the tension of the lash wire 208 in response to readings from the tension sensor 128.

The automated lash wire tension adjuster 200 may provide several benefits such as precision control, automated adjustments, and data logging. These features may enhance the quality and reliability of the lashing process, improving the performance and longevity of the lashed cable bundle 114.

Turning to FIG. 2B, the magazine housing 126 of the tension adjuster 200 includes a channel 210 that feeds the lash wire 208 from the internal portion of the magazine housing 126 to the reel guide 206. The lash wire 208 is wrapped around the reel guide 206 and the reel guide 206 rotates about the reel shaft 204 as the cable bundle lasher 112 moves along the one or more cables 106.

The tension sensor 128 includes a first protrusion 212, a second protrusion 214 and a third protrusion 216. The first protrusion 212 and the third protrusion 216 are positioned on ends of the tension sensor 128 and configured to feed the lash wire 208 from the magazine housing 126 to the reel guide 130. The second protrusion 214 is positioned between the first protrusion 212 and the third protrusion 216, and the second protrusion is positioned at a height different than the first protrusion 212 and the third protrusion 216. The second protrusion 214 includes a sensor 218 that is configured to measure tension of the lash wire 208. To measure the tension of the lash wire 208, the lash wire 208 is threaded under the first protrusion 212 over the second protrusion 214 and under the third protrusion 216, in the configuration of FIG. 2B. As the lash wire 208 is lashed to the one or more cables 106, the lash wire 208 can increase or decrease tension. In examples where the lash wire 208 tension is increasing, the lash wire 208 will exert a force downward on the second protrusion 214 and apply a force to the sensor 218 enabling the sensor 218 to measure the tension of the lash wire 208. The computing device 140 can monitor the measurements from the sensor 218 an operate the motor coupled to the reel guide 130. [0082] The reel guide 130 includes a reel shaft 220 and a surface 222. The reel shaft 220 is configured to be rotatably coupled to the tension drag wheel assembly 124. The reel shaft 220 is also configured to be coupled to a motor to operate the reel guide 130 in response to signals from the computing device 140 when tension adjustments need to be made. For example, the lash wire 208 that exits the tension sensor 128 is wrapped around the surface 222 of the reel guide 130. The surface 222 is made of a material configured to mitigate the lash wire 208 from slipping off the reel guide 130. During operation, the lash wire 208 exits the magazine housing 126, passes through the tension sensor 128, and is wrapped around the reel guide 130. As the cable bundle lasher 112 moves along the one or more cables 106, the cable bundle lasher 112 rotates about the guide cable 108 and lash wire is wrapped around the one or more cables 106 to form the cable bundle 114.

In examples where the tension of the lash wire 208 fluctuates, the motor coupled to the reel guide 130 operates in response to a signal from the computing device 140. For example, the lash wire 208 can operate within a specific tension range to prevent the lash wire 208 from either snapping or becoming too loose and unbundling the cable bundle 114. The tension threshold can be set between 10 Newtons (N) and 30 Newtons (N). If the tension sensor 128 measures a tension drop below 10 N, the computing device 140 can operate the motor coupled to the reel guide 130 and increase the reel guides 130 torque to tighten the lash wire 208. If the tension sensor 128 measures a tension increase beyond 30 N, the computing device 140 can operate the motor coupled to the reel guide 130 to decrease the torque, or can disengage the motor from the reel guide 130 to enable the reel guide 130 to spin freely to prevent the lash wire 208 from snapping.

The automated lash wire tension adjuster 200 of the cable bundle lasher 112 is configured to rotate about the one or more cables 106 as the cable bundle lasher 112 moves along the one or more cables 106 between the first structure 102 and the second structure 104. The rotation of the lash wire tension adjuster 200 enables the lash wire 208 to be applied to the one or more cables 106 in a geometry that is designed to provide a tight seal for the cable bundle 114.

Turning to FIGS. 2C and 2D, the robotic arm 144 is coupled to the automated lash wire tension adjuster 200 of the cable bundle lasher 112. The robotic arm 144 includes a first actuator 224, a second actuator 226, an extension arm 228, an end effector 230, a sensor 232, and an imaging device 234.

The robotic arm 144 is configured to provide the pulling force to move the cable bundle lasher 112 along the guide cable 108 between the first structure 102 and the second structure 104. The robotic arm 144 engages with the cable bundle 110 and pulls the cable bundle lasher 112 towards the second structure 104. In particular, the imaging device 234 scans an area to identify the cable bundle 110. The first actuator 224, the second actuator 226, and the extension arm 228 maneuver the end effector 230 (e.g., a gripping mechanism) towards the cable bundle 110. The end effector 230 is maneuvered into a position with the cable bundle 110 where the cable bundle 110 is resting on the end effector 230. This enables the sensor 232 to determine a weight of the cable bundle 110 to determine how much tension should be applied to the lash wire 208. For example, the sensor 232 on the end effector 230 can determine a weight measurement responsive to a weight of the cable bundle 110 that is positioned on the sensor 232. The computing device 140 receives the weight measurement from the sensor 232 and calculates the tension needed for the lash wire 208. The computing device 140 utilizes the weight of the cable bundle 110 along with other factors such as the type of cables, environmental conditions (e.g., wind), and the distance between the first and second structures 102, 104.

In one example, the computing device 140 can receive a weight measurement from the sensor 232 indicating that the cable bundle 110 weighs 100 kilograms. The computing device 140 can determine the tension required for the lash wire 208 utilizing the following equation:

$$Tension = weight of cable bundle \times tension factor$$

In some embodiments, the tension factor is a percentage of the weight of the cable bundle 110. For example, the tension factor can be 15% of the cable bundle's 110 weight. However, the tension factor can vary based on specific engineering requirements or safety standards. The tension factor can also be chosen based on a known amount of force required to hold the cables securely without causing damage. In other examples, the tension factor can be 5%, 10%, 25%, 35%, etc. In some embodiments, this tension equation is a desired tension and a tension threshold can be determined for the lashing procedure. For example, the tension threshold can be a range above and below the tension that is acceptable for the lashing wire to be within. The tension threshold can also include ranges for all the sensors on the cable bundle lasher 112. If any sensor detects values outside the tension threshold (e.g., excessive slope, tension, or weight), the computing device 140 can trigger an alert and possibly an automatic shutdown to prevent damage.

Using the example tension factor of 15%, the computing device 140 can determine that the tension for the lash wire 208 should be 15 kilograms (e.g., 100 kilograms×0.15). Once the 15-kilogram tension force is determined, the tension of the lash wire 208 is automatically adjusted by the lash wire tension adjuster 200 to ensure that the lash wire 208 is neither too loose (which could result in a weak lashing) nor too tight (which could damage the cables) based on the determined tension. The lash wire tension adjuster 200 adjusts the tension based on varying factors such as changes in cable weight, slope, or other variables.

In examples where the slope of the cable bundle lasher 112 is changing, the computing device 140 can calculate tension adjustment in real-time. The computing device 140 can determine the tension required for the lash wire 208 when slope angle is greater than a threshold by utilizing the following equation:

$$Tnew - Tcurrent + ( k 1 \times θ )$$

Tcurrent corresponds to the current tension, k1 corresponds to a constant that determines how much tension increases with the slope, and θ is the measured slope angle of the cable bundle lasher 112. In some examples, the threshold is 10 degrees and a slope angle that is greater than the threshold indicates that the cable bundle lasher 112 is moving in an upward direction on a cable bundle.

The computing device 140 can determine the tension required for the lash wire 208 when slope angle is less than the threshold by utilizing the following equation:

$$Tnew = Tcurrent - ( k 2 \times θ )$$

Tcurrent corresponds to the current tension, k2 corresponds to a constant for tension reduction, and θ is the measured slope angle of the cable bundle lasher 112.

In one example, the cable bundle 110 can weigh 50 kg and the slope is 15 degrees, and the cable bundle lasher can be in a starting position so the Tcurrent is the desired tension of the lash wire prior to starting the lashing process (e.g., at 0 degrees slope). Assuming k1=0.2, k2=0.5, and the tension factor is 50%:

$$Tcurrent = Tension == 50 \times \text{.5} = 25$$

$$Tnew = Tcurrent + ( k 1 \times θ ) = 25 + ( . 2 \times 15 ) = 28$$

The tension can then be adjusted to the calculated Tnew. If the tension exceeds the calculated value, the actuator will either tighten or loosen the lash wire until the tension matches the desired value. For example, if the current tension Tcurrent is higher than the Tension, the spool will unwind slightly to reduce tension.

When the tension of the lash wire 208 is determined by the computing device 140, the end effector 230 grips the cable bundle 110 and the first actuator 224, the second actuator 226, and the extension arm 228 maneuver the end effector 230 and the cable bundle 110 towards the cable bundle lasher 112, thereby positioning the cable bundle 110 in the body 116 of the cable bundle lasher 112 so the cable bundle 1110 can be lashed to the guide cable 108. During operation, the robotic arm 144 can adjust its pulling force based on both the slope and the tension feedback. If the slope increases, the robotic arm 144 applies more force to pull the cable bundle lasher 112 uphill, coordinated with the tension increase. If the slope decreases, the robotic arm 144 reduces force, coordinating with the tension reduction.

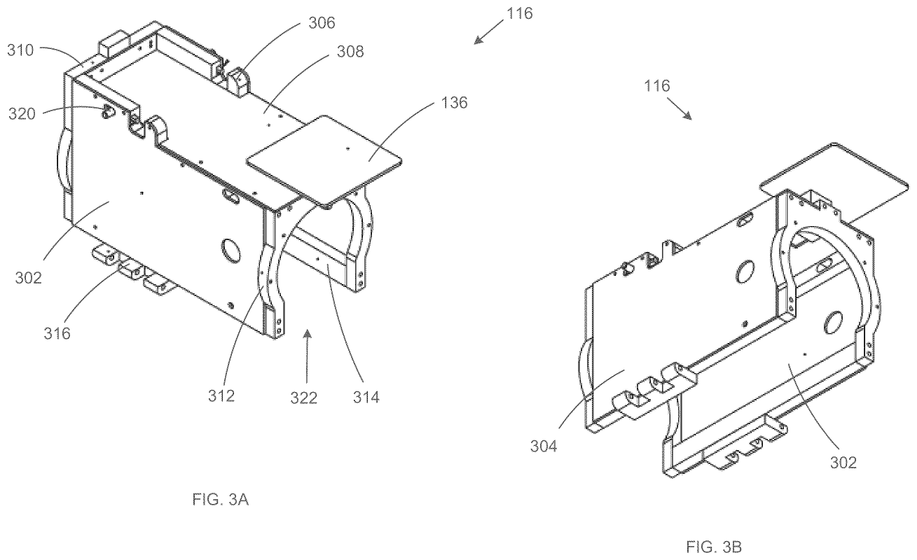

Turning to FIGS. 3A and 3B, the body 116 of the cable bundle lasher 112 includes a right side plate 302 and a left side plate 304. In some embodiments, these side plates 302, 304 provide structural support to the body 116 and can be made from a variety of materials such as metal, plastic, or composite materials.

Each of the right side plate 302 and the left side plate 304 include an upper plate support member 306. The upper plate support member 306 provides additional structural support to the body 116 and serves as a mounting point for other components of the cable bundle lasher 112. [0099] A top cover plate 308 is coupled to the right side plate 302 and the left side plate 304.

The top cover plate 308 provides protection to the internal components of the cable bundle lasher 112 from environmental factors such as rain, dust, or debris.

The body 116 also includes a back curved plate cover 310 and a front curved plate cover 312, both of which can be coupled to the right side plate 302 and the left side plate 304. These curved plate covers 310, 312 provide a streamlined shape to the body 116, reducing wind resistance and improving the movement of the cable bundle lasher 112 along the one or more cables 106.

A base plate support member 314 is positioned between the right side plate 302 and the left side plate 304 to provide additional support to the body 116. This base plate support member 314 serves as a mounting point for other components of the cable bundle lasher 112.

A hinge bracket 316 is coupled to each of the right side plate 302 and the left side plate 304 at a bottom end of the body 116. The hinge bracket 316 enables the attachment of other components to the body 116, such as the base plate 136, which can be coupled to the front curved plate cover 312.

A latch 320 is positioned adjacent the upper plate support member 306. The latch 320 is utilized to secure or release the locking mechanism 202 of the magazine housing 126. The top cover plate 308, the right side plate 302, and the left side plate 304 define a cavity 322. The cavity 322 is configured to receive the one or more cables 106 to be lashed. The cavity 322 provides a controlled environment for the lashing process, helping to ensure that the one or more cables 106 are properly aligned and secured together.

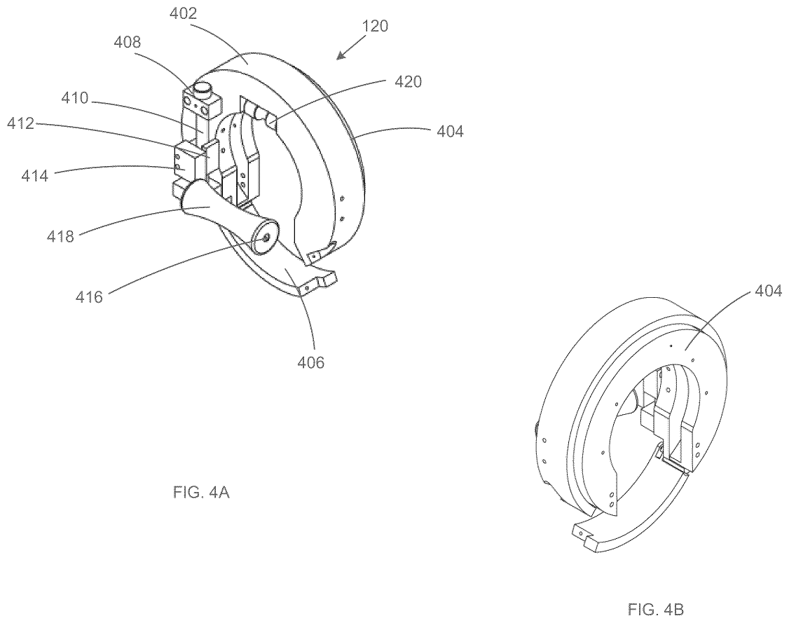

Referring now to FIGS. 4A and 4B, the back latch 120 of the cable bundle lasher 112 is coupled to the back curved plate cover 310 of the body 116. The back latch 120 secures the one or more cables 106 within the body 116, ensuring they are properly aligned for the lashing process.

The back latch 120 includes an outer curved bracket 402. The outer curved bracket 402 provides structural support to the back latch 120 and can be made from a variety of materials such as metal, plastic, or composite materials. The outer curved bracket 402 serves as a mounting point for other components of the back latch 120.

Positioned within the outer curved bracket 402 is an inner curved bracket 404. The inner curved bracket 404 provides additional structural support to the back latch 120 and assists with guiding the one or more cables 106 into the body 116. In some embodiments, the inner curved bracket 404 is configured to rotate within the outer curved bracket 402.

The back latch 120 includes a front gate 406, which is coupled to the outer curved bracket 402. The front gate 406 controls the entry of the one or more cables 106 into the body 116, ensuring they are properly aligned for the lashing process.

A rail block support 408 is coupled to the outer curved bracket 402. The rail block support 408 provides additional structural support to the back latch 120 and may also serve as a mounting point for other components of the back latch 120.

A support shaft 410 is coupled to the outer curved bracket 402 via the rail block support 408. The support shaft 410 provides structural support to the back latch 120 and may serve as a mounting and/or pivot point for other components of the back latch 120.

The back latch 120 includes a base rail 412, which is coupled to the outer curved bracket 402. The base rail 412 provides a surface for the one or more cables 106 to rest on as they are guided into the body 116.

A reel guide bracket 414 is coupled to the outer curved bracket 402 and the base rail 412. The reel guide bracket 414 guides the one or more cables 106 into the body 116, ensuring they are properly aligned for the lashing process.

The back latch 120 includes a front bow reel shaft 416, which is coupled to the reel guide bracket 414. The front bow reel shaft 416 pivots about the reel guide bracket 414 between an open and closed position, allowing for the controlled entry of the one or more cables 106 into the body 116.

A front bow reel 418 is coupled to the front bow reel shaft 416. The front bow reel 418 is configured to guide the one or more cables 106 to bundle them for the lash wire 208. This may ensure that the one or more cables 106 are properly aligned and bundled together for the lashing process.

Positioned within the outer curved bracket 402 and the inner curved bracket 404 is a front upper reel 420. The front upper reel 420 is configured to assist with guiding the one or more cables 106 into the body 116, ensuring they are properly aligned for the lashing process.

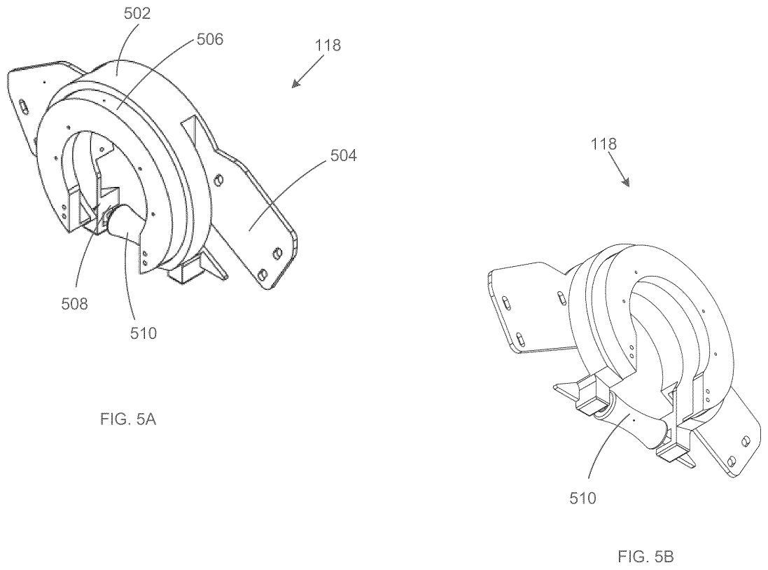

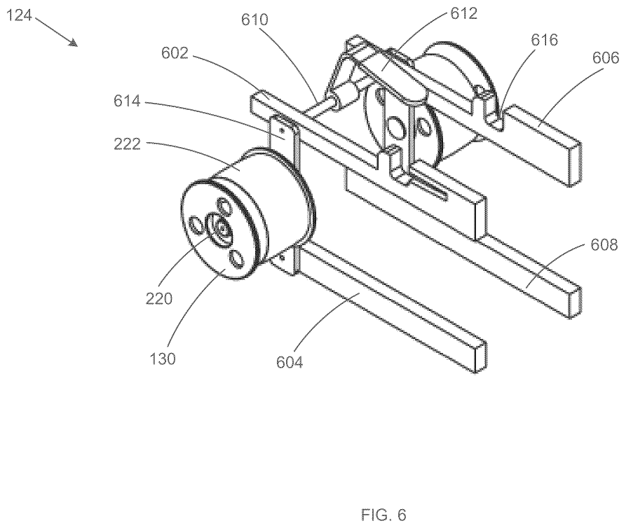

Turning now to FIGS. 5A and 5B, the front latch 118 of the cable bundle lasher 112 is coupled to the front curved plate cover 312 of the body 116. The front latch 118 secures the one or more cables 106 within the body 116, ensuring they are properly aligned for the lashing process.

The front latch 118 includes an outer curved bracket 502. In some examples, the outer curved bracket 502 provides structural support to the front latch 118 and may be made from a variety of materials such as metal, plastic, or composite materials. The outer curved bracket 502 includes one or more plates 504, which serve as mounting points for other components of the cable bundle lasher 112.

Positioned within the outer curved bracket 502 is an inner curved bracket 506. The inner curved bracket 506 provides additional structural support to the front latch 118 and guides the one or more cables 106 into the body 116.

The front latch 118 includes a back bow reel shaft 508, which is coupled to the outer curved bracket 502. The back bow reel shaft 508 is configured to pivot between an open and closed position, allowing for the controlled entry of the one or more cables 106 into the body 116. This pivoting feature provides flexibility in the lashing process, accommodating different cable sizes and configurations.

A back bow reel 510 is coupled to the back bow reel shaft 508. The back bow reel 510 is configured to guide the one or more cables 106 into the body 116, ensuring they are properly aligned for the lashing process. The back bow reel 510 provides a controlled path for the one or more cables 106, reducing the risk of cable damage or misalignment during the lashing process.

Referring now to FIG. 6, the tension drag wheel assembly 124 of the cable bundle lasher 112 includes a right upper plate support 602 and a right base plate support 604. These plate supports 602, 604 provide structural support to the tension drag wheel assembly 124 and may be made from a variety of materials such as metal, plastic, or composite materials.

Similarly, the tension drag wheel assembly 124 includes a left upper plate support 606 and a left base plate support 608. These plate supports 606, 608 provide additional structural support to the tension drag wheel assembly 124 and may also serve as mounting points for other components of the tension drag wheel assembly 124.

A handle shaft 610 is coupled to the right upper plate support 602 on one end and coupled to the left upper plate support 606 on the other end. The handle shaft 610 may provide a means for an operator or other device to maneuver the cable bundle lasher 112 along the one or more cables 106.

A handle 612 is coupled to the handle shaft 610. The handle 612 provides a grip for the operator or other device to hold and control the cable bundle lasher 112. In some cases, the handle 612 may be designed to include corresponding features of an end effector of an automated device.

The tension drag wheel assembly 124 includes an outer bracket 614. The outer bracket 614 is coupled to the right upper plate support 602 on one end and coupled to the right base plate support 604 on the other end. A similar configuration may be present for the left upper plate support 606 and the left base plate support 608. The outer bracket 614 provide additional structural support to the tension drag wheel assembly 124 and may also serve as a mounting point for other components of the tension drag wheel assembly 124. [0126] the reel shaft 220 is coupled to the outer bracket 614. The reel shaft 220 provides a rotational axis for the reel guide 130 coupled to the reel shaft 220. The reel guide 130 can be a tension spool and can be controlled by a computing device 140. The reel guide 130 can vary in operation depending on the type of cable being lashed and the desired tension of the lash wire. The reel guide 130 provides a controlled path for the lash wire, ensuring it is properly aligned and tensioned during the lashing process. This may enhance the quality and consistency of the lashed cable bundle 114, improving its performance and longevity.

The tension drag wheel assembly 124 includes locking features 616 positioned on ends of the right upper plate support 602 and the left upper plate support 606. The locking features 616 are configured to receive the locking mechanism 202 of the magazine housing 126.

The locking features and the locking mechanism 202 are configured to be positioned adjacent the upper plate support member 306 and operable between a locked position and an unlocked position via the latch 320. This enables the magazine housing 126 to be loaded with additional lash wire 208 and/or be serviced.

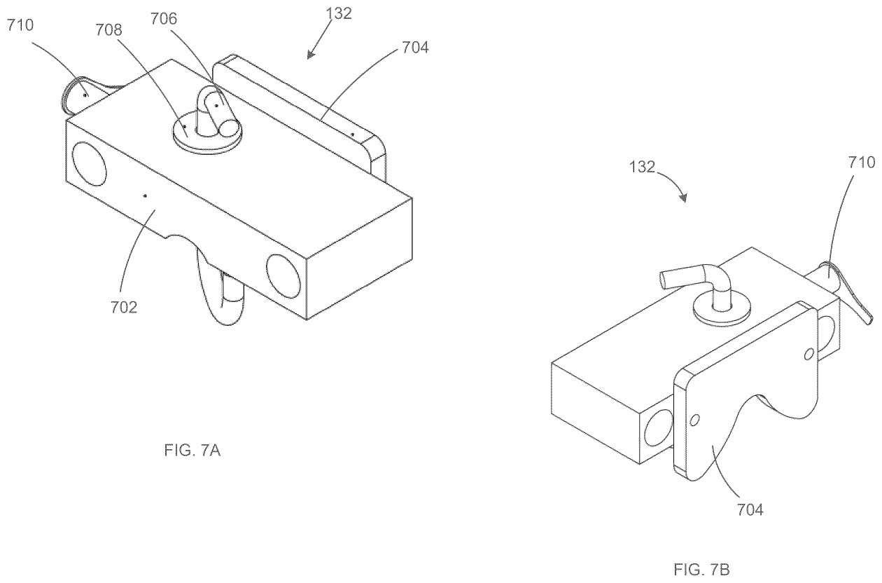

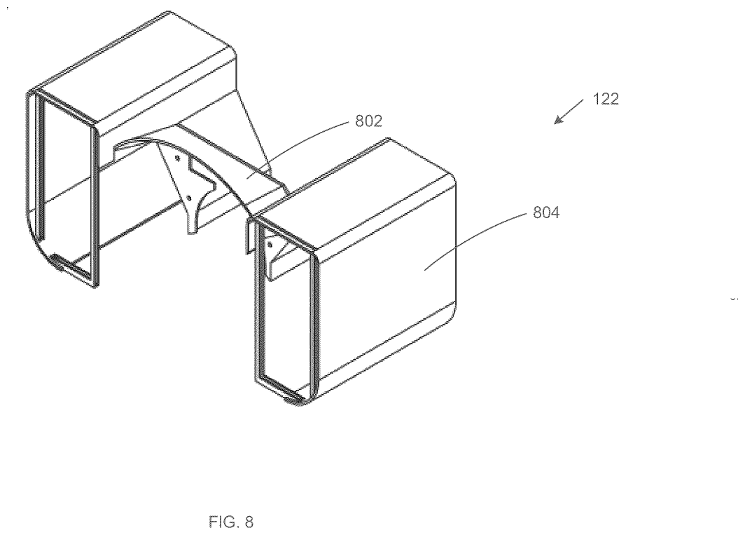

Referring now to FIGS. 7A and 7B, the cable clamp assembly 132 of the cable bundle lasher 112 is configured to secure the guide cable 108, maintaining the cable bundle lasher 112 in a stable position relative to the guide cable 108 during the lashing process. In some embodiments, the cable clamp assembly 132 includes a back platform 702. The back platform 702 provides a base structure for the cable clamp assembly 132 and may be made from a variety of materials such as metal, plastic, or composite materials.

A back plate guide 704 is coupled to the back platform 702. The back plate guide 704 serves to guide the guide cable 108 into the cable clamp assembly 132, ensuring it is properly aligned for securing to the cable clamp assembly 132. In some cases, the back plate guide 704 may be adjustable, allowing for the accommodation of different sizes or types of lashing wire. [0131] A back lock bushing 708 is positioned within the back platform 702. The back lock bushing 708 is configured to house a back lock knob 706. The back lock knob 706 used to secure the guide cable 108 within the cable clamp assembly 700, maintaining the guide cable in a stable position during the lashing process. In some embodiments, the back lock knob 706 may be adjustable, allowing for the tension of the lashing wire to be varied as needed. For example, the back lock knob 706 includes a u-shaped portion that enables the guide cable 108 to be positioned within the back lock knob 706 and then pull upward into a locked position.

A latch 710 is coupled to the back platform 702. The latch 710 serves to lock the back lock knob 706 in the locked position to secure the cable clamp assembly 132. The latch 710 is adjustable, allowing for the accommodation of different sizes or types of cables. The latch 710 includes a male feature which fits into a corresponding female feature of the back lock knob 706. For example, the guide cable 108 can be positioned into the back lock knob 706 and the back lock knob 706 can be lifted upward into a lock position. The latch 710 can be moved horizontally to position the male feature into the female feature of the back lock knob 706, thereby securing the back lock knob 706 and the guide cable 108 in the locked position.

Referring now to FIG. 8, the housing 122 of the cable bundle lasher 112 includes a bracket 802, which is coupled to the outer curved bracket 502 via the one or more plates 504. The bracket 802 provides a secure attachment point for the housing 122 to the body 116 of the cable bundle lasher 112. This ensures that the housing 122 remains firmly attached to the body 116 during the lashing process, reducing the risk of damage or misalignment.

The housing 122 includes a casing 804, which is configured to house motors and batteries to operate the cable bundle lasher 112. In some embodiments, the motors may provide the power necessary to drive the various components of the cable bundle lasher 112, such as the lashing system, the automated lash wire tension adjuster, the actuator assembly, and/or wheels. The batteries may provide a portable power source for the cable bundle lasher 112, allowing it to operate in a variety of environments without the need for a constant external power supply. The casing 804 protects these components from environmental factors such as dust, moisture, and impact, ensuring they remain operational and effective throughout the lashing process.

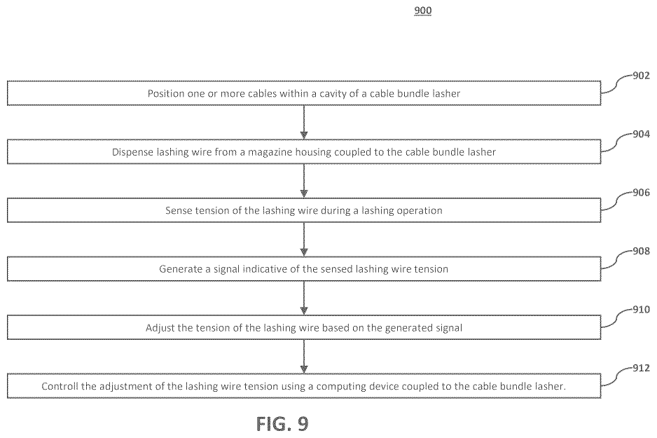

Referring to FIG. 9 a method 900 of adjusting tension of lash wire includes positioning one or more cables within a cavity of a cable bundle lasher (step 902). For example, the cable bundle lasher 112 can be positioned on the one or more cables 106. In particular, the one or more cables 106 can be positioned within the cavity 322 of the body 116 of the cable bundle lasher 112 and the front latch 118 and the back latch 120 can be closed to lock the one or more cables 106 within the cavity 322.

The method 900 also includes dispensing lashing wire from a magazine housing coupled to the cable bundle lasher (step 904). For example, the robotic arm 144 can pull the cable bundle lasher 112 along the guide cable 108 and the lash wire 208 can be dispensed from the magazine housing 126 and wrapped around the guide cable 108 and the cable bundle 110 to form the lashed cable bundle 114.

The method 900 also includes sensing tension of the lashing wire during a lashing operation (step 906). For example, the tension sensor 128 can measure the tension of the lash wire 208 as the lash wire 208 is dispensed from the magazine housing 126, wrapped around the reel guide 130 and lashed onto the one or more cables 106.

The method 900 also includes generating a signal indicative of the sensed lashing wire tension (step 908). For example, the tension sensor 128 can generate a measurement that is received by the computing device 140. The computing device 140 monitors the measurements from the tension sensor 128 to ensure the lash wire 208 is within a threshold tension range (e.g., 10 N to 30 N).

The method 900 also includes adjusting the tension of the lashing wire based on the generated signal (step 910). The method 900 can also include controlling the adjustment of the lashing wire tension using a computing device coupled to the cable bundle lasher (step 912). For example, the lash wire 208 can operate within a specific tension range to prevent the lash wire 208 from either snapping or becoming too loose and unbundling the cable bundle 114. The tension threshold can be set between 10 Newtons (N) and 30 Newtons (N). If the tension sensor 128 measures a tension drop below 10 N, the computing device 140 can operate the motor coupled to the reel guide 130 and increase the reel guides 130 torque to tighten the lash wire 208. If the tension sensor 128 measures a tension increase beyond 30 N, the computing device 140 can operate the motor coupled to the reel guide 130 to decrease the torque, or can disengage the motor from the reel guide 130 to enable the reel guide 130 to spin freely to prevent the lash wire 208 from snapping.

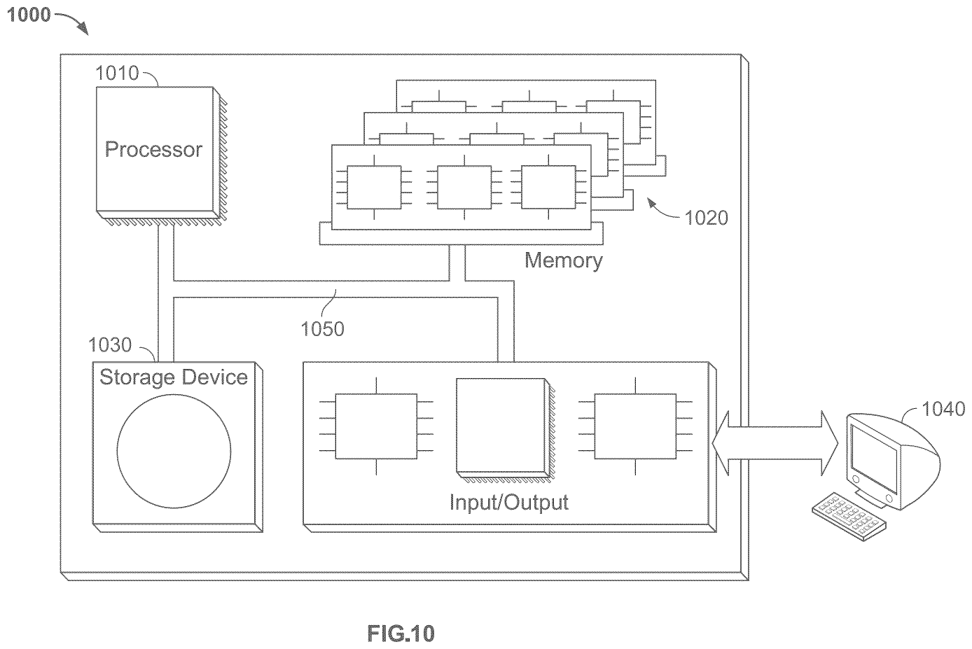

FIG. 10 shows a schematic drawing of a control system 1000 of the example cable bundle lasher 112 of FIGS. 1A-8. All or parts of the control system (or controller) 1000 can be used for the operations described previously, for example as or as part of the computing device 140. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives can store operating systems and other applications. The USB flash drives can include input/output components, such as a wireless transmitter or USB connector that can be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor can be designed using any of a number of architectures. For example, the processor 1010 can be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the control system 1000. In one implementation, the memory 2020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 can be a floppy disk device, a hard disk device, an optical disk device, a tape device, flash memory, a solid state device (SSD), or a combination thereof.

The input/output device 1040 provides input/output operations for the controller 1000. In one implementation, the input/output device 1040 includes a keyboard and/or pointing device.

In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

The present disclosure provides a system for securing and managing cables in various settings such as telecommunications infrastructure or utility installations. This system, referred to as a cable bundle lasher, may be designed to be positioned on one or more cables and includes several key components that contribute to its functionality.

One such component is a body, which may be configured to receive and house the cables. The body may be designed to accommodate a variety of cable types and sizes, providing flexibility for different applications.

Another component is a lash wire magazine, which may be coupled to the body. The lash wire magazine may hold a spool of lash wire intended for wrapping around the cables. The magazine may include a first reel guide to guide the lash wire as it exits the spool, ensuring a smooth and consistent application of the lash wire around the cables.

The cable bundle lasher may also include an automated lash wire tension adjuster. The lash wire tension adjuster is coupled to the body and is configured to receive the lash wire from the magazine. The lash wire tension adjuster may include a tension sensor responsive to lash wire tension during operation of the lasher, and a local tension adjuster configured to adjust lash wire tension in response to a signal indicative of the sensed lash wire tension. This automated tension adjuster may provide precise control over the tension of the lash wire, enhancing the quality and reliability of the lashing process.

Additionally, the cable bundle lasher may include an actuator assembly. This assembly, also coupled to the body, may be designed to secure the lashing wire to the one or more cables. The actuator assembly may include a base actuator, a link actuator coupled to the base actuator, and an end effector coupled to the link actuator. The end effector may be positioned on the lashing wire that has been wrapped around the one or more cables to maintain lash wire tension, ensuring a secure and stable lashing of the cables.

In some embodiments, the cable bundle lasher may also include a computing device coupled to the body. This computing device may be configured to control the automated lash wire tension adjuster and the actuator assembly based on measurements from the tension sensor, providing automated and precise control over the lashing process.

The cable bundle lasher system as described in this disclosure may offer an efficient and reliable solution for managing and securing cables in various applications.

A number of implementations have been described. Nevertheless, it will be understood that various modifications can be made without departing from the spirit and scope of the disclosure. For example, example operations, methods, or processes described herein can include more steps or fewer steps than those described. Further, the steps in such example operations, methods, or processes can be performed in different successions than that described or illustrated in the figures. Accordingly, other implementations are within the scope of the following claims.

What is claimed is:

1. A cable bundle lasher, comprising:
a body configured to be positioned on one or more cables;
a lash wire magazine coupled to the body and configured to hold a spool of lash wire for wrapping around the one or more cables, the magazine comprising a first reel guide to guide lash wire exiting the spool;
an automated lash wire tension adjuster coupled to the body and configured to receive the lash wire from the magazine, the automated lash wire tension adjuster comprising:
a tension sensor responsive to lash wire tension during operation of the lasher; and
a local tension adjuster configured to receive a signal indicative of lash wire tension and to adjust lash wire tension in response to the signal.

2. The cable bundle lasher of claim 1, further comprising:
a tension support structure coupled to the body, the tension support structure including an upper plate;
a base plate; and
an outer bracket coupling the upper plate to the base plate.

3. The cable bundle lasher of claim 2, further comprising:
a reel shaft that is coupled to the outer bracket.

4. The cable bundle lasher of claim 3, further comprising:
a second reel guide that is coupled to the reel shaft.

5. The cable bundle lasher of claim 4, wherein the local tension adjuster is a motor or an electric actuator.

6. The cable bundle lasher of claim 4, wherein the first reel guide operates about a vertical axis.

7. The cable bundle lasher of claim 5, wherein the second reel guide comprises one or more tension drag wheels, and wherein the second reel guide operates about a horizontal axis.

8. The cable bundle lasher of claim 1, wherein the tension sensor comprises a strain gauge or load cell configured to measure a force applied to the lashing wire.

9. The cable bundle lasher of claim 1, wherein the tension sensor comprises a three-roller tension sensor.

10. The cable bundle lasher of claim 1, further comprising:
a computing device coupled to the body, wherein the computing device is configured to monitor measurements from the tension sensor and operate the local tension adjuster to maintain tension of the lash wire.

11. A cable bundle lasher, comprising:
a body defining a cavity configured to receive one or more cables;
a lashing wire dispenser coupled to the body and configured to dispense lashing wire; a tension sensor responsive to lash wire tension during operation of the lasher;
a local tension adjuster configured to receive a signal indicative of lash wire tension and to adjust lash wire tension in response to the signal; and
a computing device coupled to the body, wherein the computing device is configured to monitor measurements from the tension sensor and operate the local tension adjuster to maintain tension of the lash wire.

12. The system of claim 11, wherein the tension sensor comprises a strain gauge or load cell.

13. The cable bundle lasher of claim 11, wherein the local tension adjuster comprises an electric actuator configured to adjust tension of the lashing wire.

14. The cable bundle lasher of claim 11, further comprising:
a robotic arm assembly coupled to the body and configured to manage the one or more cables prior to entering the cavity.

15. A system for automated cable bundle lashing, comprising:
a cable bundle lasher including a body defining a cavity for receiving one or more cables; a lashing wire dispenser coupled to the cable bundle lasher;
an automated lash wire tension adjuster including:
a tension sensor responsive to lash wire tension, and
a local tension adjuster configured to adjust lash wire tension; and
a computing device coupled to the cable bundle lasher and configured to control the automated lash wire tension adjuster based on measurements from the tension sensor.

16. The system of claim 15, wherein the tension sensor comprises a strain gauge or load cell configured to measure force applied to the lashing wire.

17. The system of claim 15, wherein the local tension adjuster comprises an electric actuator configured to adjust tension of the lashing wire based on signals from the computing device.

18. The system of claim 15, further comprising:
a robotic arm assembly coupled to the cable bundle lasher and configured to manage the one or more cables prior to entering the cavity.

19. The system of claim 15, wherein the computing device is configured to execute at least one of an initialization procedure, an acquisition procedure, an analysis procedure, a tension adjustment procedure, a speed procedure, and a completion procedure.

20. The system of claim 19, wherein the tension adjustment procedure comprises:
determining a tension measurement based on a weight of the one or more cables and a tension factor; and
determining an adjusted tension measurement based on the tension measurement, a tension increase factor, and a slope angle.
